(19) United States
(12) Patent Application Publication
(10) Pub. No.: US 2007/0016938 A1
(43) Pub. Date: Jan. 18, 2007

(54) Apparatus and method for identifying safe data in a data stream

(75) Inventor: Yeejang Lin, San Jose, CA (US)

Correspondence Address: CARLTON FIELDS, PA, 1201 WEST PEACHTREE STREET, 3000 ONE ATLANTIC CENTER, ATLANTA, GA, 30309, US

(73) Assignee: Reti Corporation

(21) Appl. No.: 11/176,454

(22) Filed: Jul. 7, 2005

(51) Int. Cl. H04L 9/32

(52) U.S. Cl. 726/3

(57) ABSTRACT

An apparatus and method for enabling rapid transfer of safe data in a data communication network. The apparatus includes a plurality of matrices and a database of unsafe data. A predetermined portion of the unsafe data's signature is populated to a corresponding position in each matrix, and the signature of a received data is compared against a plurality of matrices. If the signature of the received data does not match any element in the plurality of matrices, the received data is marked as safe data.

### BACKGROUND OF THE INVENTION

1. Field of the Invention

The present invention generally relates to data communications, and more specifically, relates to a system and method for providing security in during data transfers.

2. Description of the Related Art

Computer viruses and worms have caused millions dollars in computer and network downtimes and they made computer virus detection and elimination a thriving industry. Now, every computer is equipped with computer virus detection and prevention software, and every data network gateway is guarded with equally powerful virus detection and prevention software.

Computer virus, bugs, and worms are undesirable software developed by computer hackers or computer whiz kids, who are either testing their programming skills or having other ulterior motives. Like any software, each of these undesired viruses, bugs and worms have a unique digital signature. Once a virus became known, its digital signature is cataloged and made public. Once a virus's signature is known, computer virus prevention software can test incoming data in a data stream for this particular signature. If an incoming data contains this signature, then it is flagged as unsafe data and rejected.

The computer virus prevention software tests an incoming data against signatures of all known viruses, which number is in tens of thousands and still growing. Comparing each incoming data against a growing database of known viruses can be time consuming and slows down data traffic. To ensure a virus free environment, this comparison or screening of data is performed by all network gateways and on every single computer. This “global” comparison slows down substantially the data traffic, even when the majority of the data trafficking in a network at any given time is free of viruses, i.e., they are safe data.

Therefore, it is desirous to have an apparatus and method that enable rapid transfer of safe data in a data communication system, and it is to such apparatus and method the present invention is primarily directed.

### SUMMARY OF THE INVENTION

Briefly described, an apparatus and method of the invention enables expeditious processing of an incoming data by quickly identifying safe data and releasing them for further processing. In one embodiment, there is provided a method for a computing device to identify safe data in a data stream, wherein the data stream is received from a network and may contain unsafe data. Each unsafe datum is identified by a unique data signature and the computing device has a plurality of unsafe data signatures identifying unsafe data. The method includes creating at least one matrix that has a first number of elements, for each unsafe data signature in the plurality of the unsafe data signatures, analyzing a first predetermined portion of a unsafe data signature, marking a position in the at least one matrix for each analysis result of each unsafe data signature, analyzing the data stream, comparing an analysis result with the at least one matrix, and, if a position in the at least one matrix corresponding to the at least one analysis result is un-marked, identifying the data stream as safe data.

In another embodiment, there is provided an apparatus for identifying safe data in a data stream, wherein the data stream is received from a network and may contain unsafe data and each undesirable datum is identified by a unique data signature. The apparatus includes a data receiver for receiving data from a data source, a plurality of filtering matrices, and a data analyzer for analyzing the received data against the plurality of filtering matrices. Each filtering matrix has a plurality of elements, and each element has two distinguished states, wherein a data signature of an unsafe datum is represented by a plurality of elements in a first state distributed among the plurality of filtering matrices. If the received data do not match to any element in the first state in the plurality of the matrices, the received data is classified as safe data.

In yet another embodiment, there is provided an apparatus for identifying safe data in a data stream, wherein the data stream is received from a network and may contain unsafe data and each unsafe datum being identified by a unique data signature. The apparatus includes a data receiver for receiving data from a data source, a database of unsafe data with a plurality of entries, a plurality of matrices, and a content pre-filtering engine for comparing a received data with a predetermined portion of each unsafe datum. Each entry of the database has an unsafe datum, and each filtering matrix has a plurality of elements, wherein each element has two distinguished states. The predetermined portion is less than the entire unsafe datum.

The present system and methods are therefore advantageous as they enable rapid transfer of safe data in a data communication system. Other advantages and features of the present invention will become apparent after review of the hereinafter set forth Brief Description of the Drawings, Detailed Description of the Invention, and the Claims.

### BRIEF DESCRIPTION OF THE DRAWINGS

FIG. 1 depicts a data flow for a pre-filtering process.

FIG. 2 illustrates an example of a virus database.

FIG. 3 depicts a table of signatures of a virus database.

FIG. 4 illustrates a visualization of a pre-filtering process.

FIG. 5 illustrates a stream of incoming data.

FIG. 6 illustrates an exemplary architecture of one embodiment of the invention.

FIG. 7 illustrates an exemplary flow chart for a pre-filtering process.

### DETAILED DESCRIPTION OF THE INVENTION

In this description, the term “application” as used herein is intended to encompass executable and nonexecutable software files, raw data, aggregated data, patches, and other code segments. The term “exemplary” is meant only as an example, and does not indicate any preference for the embodiment or elements described. Further, like numerals refer to like elements throughout the several views, and the articles “a” and “the” includes plural references, unless otherwise specified in the description.

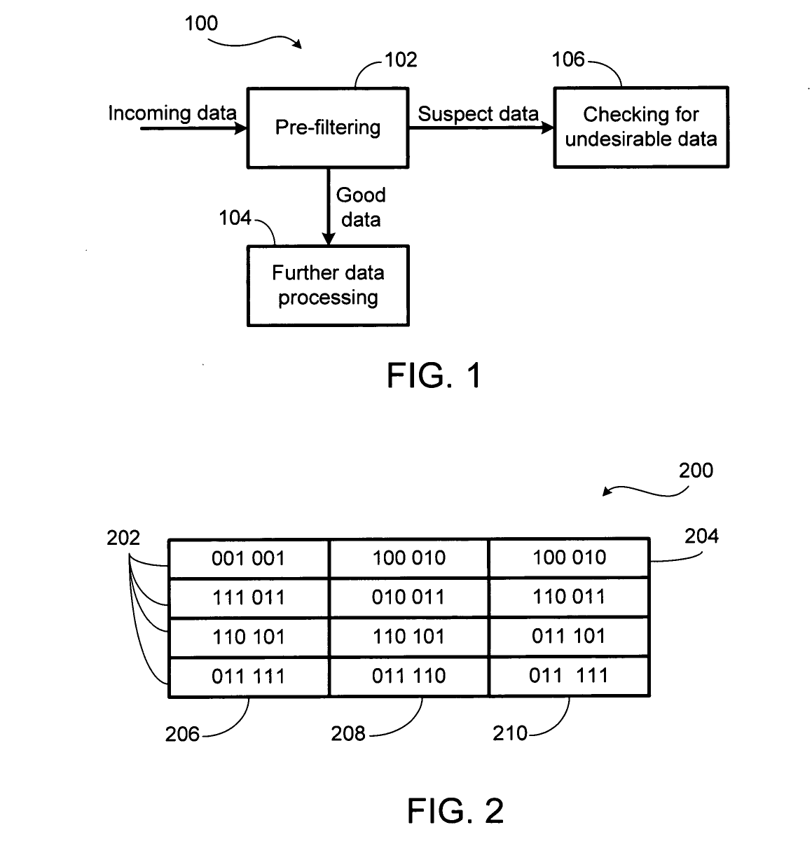

In overview, the present system and method enables fast transfer of safe data by identifying the safe data through comparison with a plurality of matrices. FIG. 1 depicts the data flow 100 according to the basic principle of the pre-filtering mechanism of the invention. As stated above, the majority of incoming data is safe data and they should be handled quickly, so as not to hinder the performance of a system. Only the suspect data should be further analyzed. All incoming data pass through pre-filtering 102, where the incoming data are compared with a database of known unsafe data. The good data are identified and sent to their destination for further processing 104; the suspect data, i.e., those data that failed the pre-filtering are sent for further checking 106.

The pre-filtering is done by comparing the signature of an incoming data with signatures of known unsafe data, which includes virus, spyware, attacks, and unauthorized contents. However, instead of comparing the signature of the incoming data with signatures of every known unsafe data, the pre-filtering compares the signature of the incoming data with a select portion of every unsafe data. If there is no match, then the incoming data is classified as safe data. If a portion of the signature of the incoming data matches the select portion of an unsafe data, then the incoming data is a suspect data, i.e., the incoming data may contain unsafe data. To further verify the incoming data, a subsequent portion of the signature of the incoming data is compared against a next select portion of every unsafe data. If there is no match in this second match, then the previous match is a false positive and the incoming data is safe. If the subsequent portion of the signature of the incoming data matches the next select portion of an unsafe data, the possibility of the incoming data being an unsafe data increases. The system can select to perform complete analysis of the incoming data if the possibility reaches a certain level. The possibility can be adjusted by controlling the number of matches is performed on the incoming data. The larger the number of the comparisons the larger is the possibility the incoming data is an unsafe data if the incoming data matches all the comparisons.

The comparisons may be accomplished in different ways. An expeditious way the comparison can be done is by creating a matrix of M×N elements, where each element may be zero or one. Initially the elements are unset and an element may be set if its position corresponds to a select portion of the signature of an unsafe data. When checking the incoming data, a predetermined portion of the signature of the incoming data is compared with an element corresponding to the predetermined portion of the signature of the incoming data. If the element is set, then there is a possibility that the incoming data may be an unsafe data, and further analysis may be warranted.

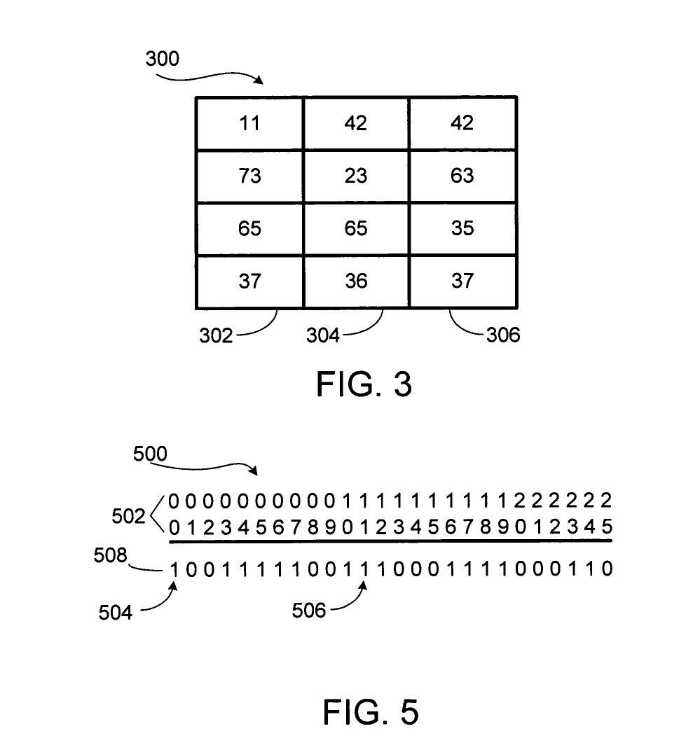

FIGS. 2 and 3 are a simple illustration of the comparison described above. For simplicity and easy representation, we will set a byte size to three bits and a word size to six bits. FIG. 2 illustrates a database 200 of known virus. The database has a plurality of entries 202, in each entry is stored the signature of a virus. For example, entry 204 has a signature, 001 001 100 010 100 010, which in an octonary representation it would be 11 42 42.

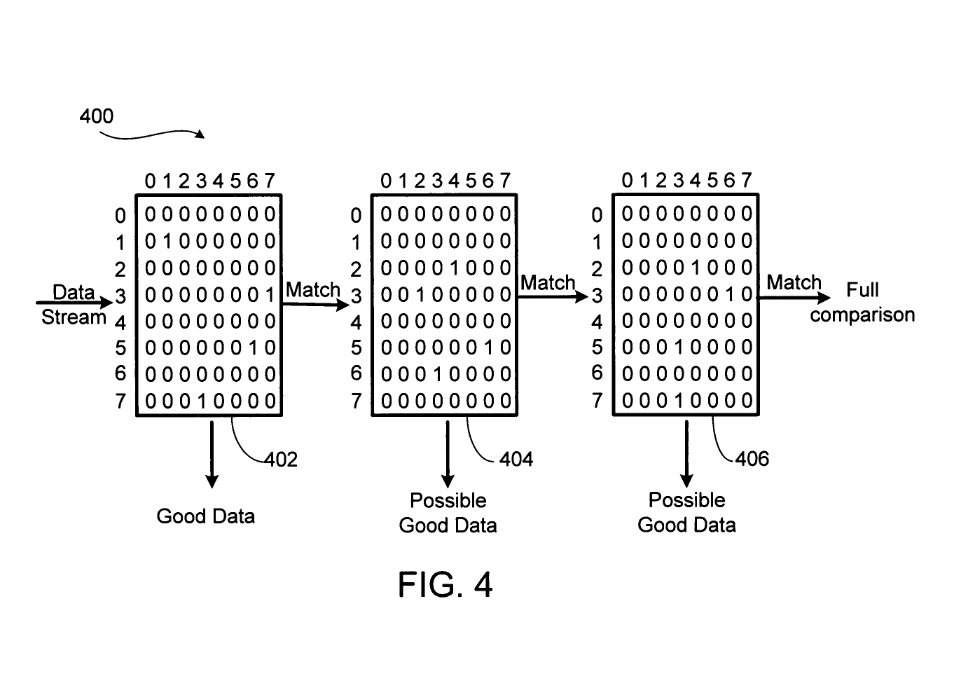

Octonary representations for all the entries in illustrated in FIG. 3. The information on FIG. 3 may be represented by three 8×8 matrices, wherein each column 302, 304, 306 is represented by one 8×8 matrix. FIG. 4 illustrates three 8×8 matrices, 402, 404, 406, representing the signatures of the known virus from FIG. 3. In the first matrix 402, it is represented information from column 302. The column 302 includes portions of each signature and they are (11, 72, 65, 37). Placing these numbers into matrix 402 and taking the first digit to represent X coordinate and the second digit to represent Y coordinate, the position (1, 1) is set to one to represent 11. The position (7, 2) is set to represent 72, the position (6, 5) is set to represent 65, and the position (3, 7) is set to represent 37. The information in columns 304 and 306 are similarly represented in matrices 404 and 406. Those skilled in the art will appreciate that the matrices can be set to three dimension, four dimension, etc.

The matrices in FIG. 4 can then be used to check for safe data in an incoming data stream. Each incoming data stream has a data signature associated with it. Each portion of the data signature is compared with the matrix 402. If the position corresponding to the portion of the data signature is unset, i.e., not marked with one, then that portion of the data signature is safe and the comparison is repeated for a subsequent portion. If no part of the signature of the incoming data matches to a set bit in the matrix 402, then the incoming data is a safe data and can be forwarded for further processing. There is no need to further compare the signature of the incoming data with matrices 404 and 406.

However, if a portion of the signature of the incoming data matches a set bit in the matrix 402, then a subsequent portion of the same signature is compared against the matrix 404 in a similar manner. If there is no match in the matrix 404, then a new shifted portion of the same signature is compared with the matrix 402 and the operations described above are repeated. On the other hand, if there is a match in the matrix 404, then another portion (a new shifted portion) of the signature is compared against the matrix 406. If there is a match again in the matrix 406, the incoming data is a good candidate for a complete analysis, where the incoming data will be matched against all known virus. If there is no match, another new portion of the same signature is compared with the matrix 402 and operations described above are repeated.

Having matched three matrices does not mean necessary the incoming data contains a virus; it may be a false positive case, where there are positive indications of a presence of a virus, but further a further analysis may prove the incoming data does not contain any virus. The possibility of a false positive can be reduced by increasing the number of matrices used for comparison. Taking the example of FIG. 4, the possibility of a match in each of the matrices 402, 404, and 406 is 4/64 (four out of 64 possibilities). The possibility of a false positive after an incoming data passes through three matrices is ( 4/64)³, which is approximately 0.025%.

The matrices described above can be implemented either in hardware, for example using registers, or in software, for example using data arrays. The matrices can be reloaded at any time and the performance is not affected by the size of signatures.

FIG. 5 illustrates an example 500 involving one incoming data stream 508. Two rows of numbers 502 denote the position of each incoming data bit. For example, the first bit 504 is at position 0, and bit 506 is at position 11. Following the description above, an octonary system is used and the incoming bits are analyzed six bits each time. Initially a mask selects the first six bits (100 111) to be analyzed analyzed. The signature for these six bits in the octonary system is 47, and this number is used as coordinates to check against the first matrix 402. There is no match since the element in the position (4, 7) is not set. Then the mask is shifted one bit and the next set of bits is selected for analysis are 001 111, which is 17 in the octonary system. Again there is no match and the mask is shifted again. The next set of bits are 011 111, which is 37 in the octonary system. When checking “37” against the matrix 402, there is a match because the element at the position (3, 7) is set.

When there is a match, the incoming data stream is flagged as potentially having a virus and should be further checked. To reduce the possibility of a false positive, the next set of bits, 001 110, are checked against the next matrix 404. If the incoming data stream has a virus, it must include the entire signature of the virus. The signature of the next set of bits in the octonary system is 15 and is checked against the matrix 404. There is no match in the matrix 404 since the element at the position (1, 5) is not set. Because there is no match, the regular checking by shifting the mask is resumed and the bits 111 110 are selected for analysis against the matrix 402. The process continues until the entire incoming data are checked against the matrices.

If there are matches against three matrices, then the incoming data is selected for a full comparison against the entire virus database. Since most of data are virus free, the majority of data will be released for processing after passing through this pre-filtering stage. Only those data that have matches in all three matrices will be analyzed in detail. This approach quickly frees up the majority of data for normal processing, and thus increasing the performance of a system.

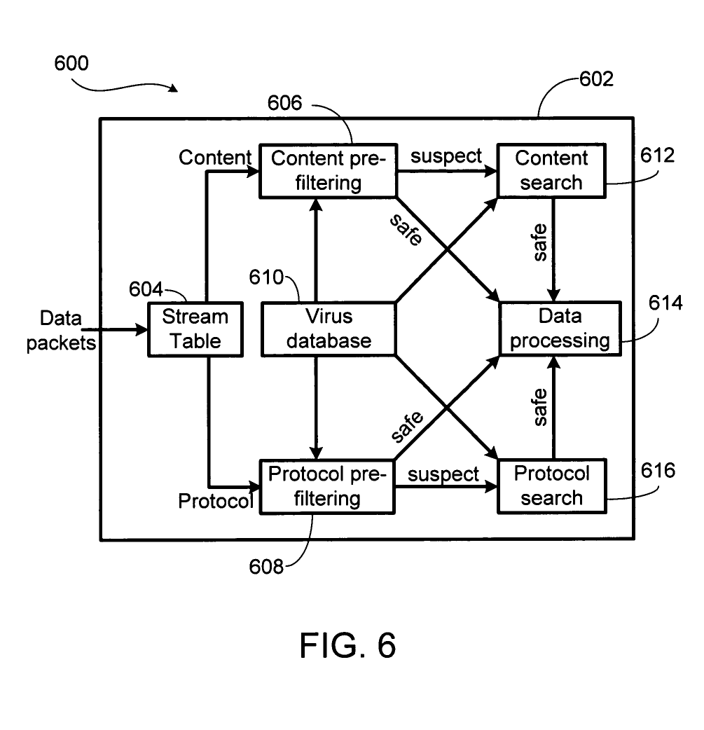

FIG. 6 illustrates an exemplary architecture 600 of a system 602 supporting the invention. Data packets for an application are received from a network are processed by a stream table 604. The protocol portion of the data is sent to a protocol pre-filtering unit 608 and the content portion of the data is sent to a content pre-filtering unit 606. The following description will concentrate on the pre-filtering of the content. A virus database 610 provides information on known virus to the pre-filtering unit 606. The pre-filtering described above in conjunction with FIGS. 3-5 is performed by the content pre-filtering unit 606. If a content (a data stream) is found to be suspicious, it is forwarded to a content search unit 612, where the content will be fully searched against all known virus from the virus database 610. If the content is found to be safe, it is forwarded to a data processing unit 614. If the content sent to the content search unit 612 is found to be safe, the case of a false positive, the content is also forwarded to the data processing unit 614. If the content is found to have virus, it is quarantined and may be destroyed. The virus database 610 should be constantly updated with the latest virus information. Other elements, such as a controller and input/output units, not essential to the description of pre-filtering are not illustrated and described here.

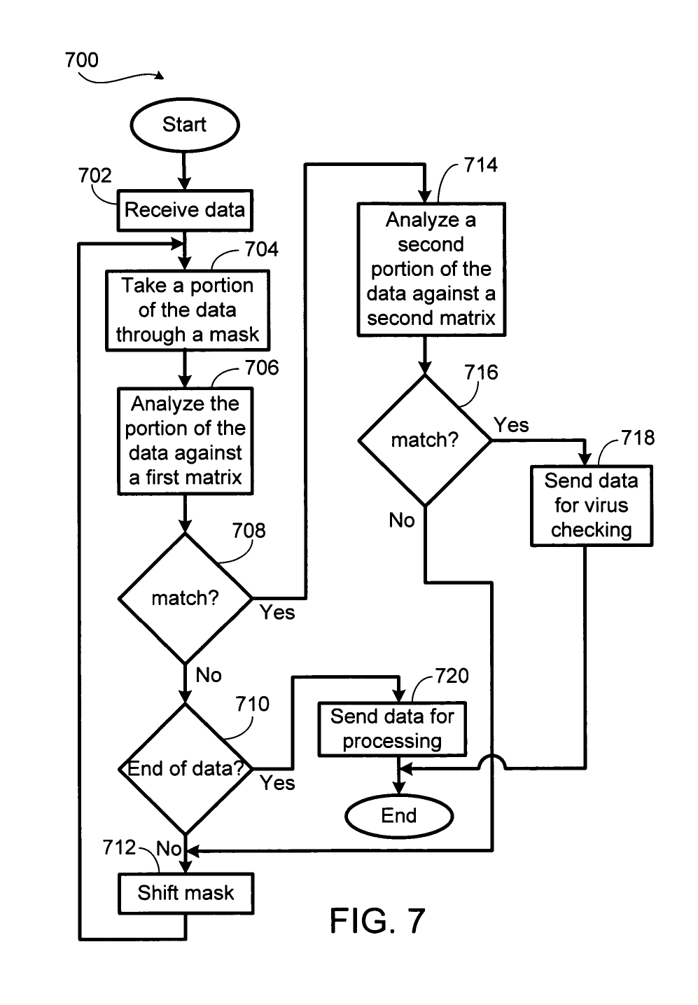

FIG. 7 is an exemplary flow chart 700 of a pre-filtering process with two matrices. A system receives data from a network, step 702, and takes a portion of the data through a mask, step 704. The data portion taken through the mask is matched against a first matrix, step 706. If there is not match, the process checks if it is at the end of the data, step 710. If it is not the end of the data, the mask is shifted, step 712, and the next portion of the data is taken and steps 704-706 are repeated.

If, when comparing a portion of the data with a first matrix, there is a match, then a second portion of the data is matched against a second matrix, step 714. If there is another match against the second matrix, then the chance of the data containing a virus increases and the data maybe sent for a complete checking against virus, step 718. If there is no match in this second matrix, then the mask is shifted to take a new portion of the data for analysis against the first matrix and the process repeats until the end of the data. When the entire data have been analyzed and no match was found, then the data is sent for processing, step 720. Those skilled in the art will appreciate that the process illustrated in FIG. 7 can be adapted for checking an incoming data against three, four, or any number of matrices.

In view of the method being executable on networking devices and servers, the method can be performed by a program resident in a computer readable medium, where the program directs a server or other computer device having a computer platform to perform the steps of the method. The computer readable medium can be the memory of the server, or can be in a connective database. Further, the computer readable medium can be in a secondary storage media that is loadable onto a networking computer platform, such as a magnetic disk or tape, optical disk, hard disk, flash memory, or other storage media as is known in the art.

In the context of FIG. 7, the steps illustrated do not require or imply any particular order of actions. The actions may be executed in sequence or in parallel. The method may be implemented, for example, by operating portion(s) of a network device, such as a network router or network server, to execute a sequence of machine-readable instructions. The instructions can reside in various types of signal-bearing or data storage primary, secondary, or tertiary media. The media may comprise, for example, RAM (not shown) accessible by, or residing within, the components of the network device. Whether contained in RAM, a diskette, or other secondary storage media, the instructions may be stored on a variety of machine-readable data storage media, such as DASD storage (e.g., a conventional “hard drive” or a RAID array), magnetic tape, electronic read-only memory (e.g., ROM, EPROM, or EEPROM), flash memory cards, an optical storage device (e.g. CD-ROM, WORM, DVD, digital optical tape), paper “punch” cards, or other suitable data storage media including digital and analog transmission media.

While the invention has been particularly shown and described with reference to a preferred embodiment thereof, it will be understood by those skilled in the art that various changes in form and detail may be made without departing from the spirit and scope of the present invention as set forth in the following claims. Furthermore, although elements of the invention may be described or claimed in the singular, the plural is contemplated unless limitation to the singular is explicitly stated.

What is claimed is:

1. A method for a computing device to identify safe data in a data stream, wherein the data stream is received from a network and may contain unsafe data, each unsafe datum being identified by a unique data signature and the computing device having a plurality of unsafe data signatures identifying unsafe data, comprising the steps of:
creating at least one matrix, the at least one matrix having a first number of elements;
for each unsafe data signature in the plurality of the unsafe data signatures, analyzing a first predetermined portion of an unsafe data signature;
marking a position in the at least one matrix for each analysis result of each unsafe data signature;
analyzing the data stream;
comparing an analysis result with the at least one matrix; and
if a position in the at least one matrix corresponding to the at least one analysis result is un-marked, identifying the data stream as safe data.

2. The method of claim 1 further comprising the step of, if a position in the at least one matrix corresponding to the at least one analysis result is marked, identifying the data stream as unsafe data.

3. The method of claim 1, wherein the step of analyzing the data stream further comprising steps for:
a) analyzing a predetermined portion of the data stream;
b) obtaining a partial result;
c) shifting the predetermined portion by a selected amount; and
d) repeating steps a), b), and c) for the entire data stream.

4. The method of claim 3, wherein the step of comparing an analysis result further comprising the step of comparing each partial result from a predetermined portion of the data stream with one corresponding position in the at least one matrix.

5. An apparatus for identifying safe data in a data stream, wherein the data stream is received from a network and may contain unsafe data, each undesirable datum being identified by a unique data signature, comprising:
a data receiver for receiving data from a data source;
a plurality of filtering matrices, each filtering matrix having a plurality of elements, each element having two distinguished states, wherein a data signature of an unsafe datum is represented by a plurality of elements in a first state distributed among the plurality of filtering matrices; and
a data analyzer for analyzing the received data against the plurality of filtering matrices, wherein if the received data do not match to any element in the first state in the plurality of the matrices, the received data is classified as safe data.

6. The apparatus of claim 5, wherein the data receiver is capable of ordering the received data.

7. The apparatus of claim 5, further comprising a database of unsafe data.

8. The apparatus of claim 5, further comprising a content search engine for analyzing the received data that is classified as unsafe data.

9. The apparatus of claim 5, further comprising a data processing unit for processing the safe data.

10. An apparatus for identifying safe data in a data stream, wherein the data stream is received from a network and may contain unsafe data, each unsafe datum being identified by a unique data signature, comprising:
a data receiver for receiving data from a data source;
a database of unsafe data, the database having a plurality of entries, each entry having an unsafe datum;
a plurality of matrices, each filtering matrix having a plurality of elements, each element having two distinguished states; and
a content pre-filtering engine for comparing a received data with a predetermined portion of each unsafe datum, the predetermined portion being less than the entire unsafe datum.

11. The apparatus of claim 10, wherein the data receiver is capable of ordering the received data.

12. The apparatus of claim 10, wherein a data signature of an unsafe datum is represented by a plurality of elements in a first state distributed among the plurality of filtering matrices.

13. The apparatus of claim 12, wherein the content pre-filtering engine analyzes the received data against the plurality of filtering matrices, wherein if the received data do not match to any element in the first state in the plurality of the matrices, the received data is classified as safe data.

14. The apparatus of claim 10, wherein the content pre-filtering engine marks the received data as unsafe data if the received data matches the predetermined portion of any unsafe datum.

15. The apparatus of claim 10, wherein the content pre-filtering engine marks the received data as safe data if the received data does not match the predetermined portion of any unsafe datum.

16. The apparatus of claim 15, further comprising a data processing unit for processing the safe data.

17. A computer-readable medium on which is stored a computer program for a computing device to identify safe data in a data stream, wherein the data stream is received from a network and may contain unsafe data, each unsafe datum being identified by a unique data signature and the computing device having a plurality of unsafe data signatures, the computer program comprising computer instructions that when executed by a computing device performs the steps for:
devising at least one matrix, the at least one matrix having a first number of elements;
for each data signature in the plurality of the unsafe data signatures, analyzing a first predetermined portion of an unsafe data signature;
marking a position in the at least one matrix for each analysis result of each unsafe data signature;
analyzing the data stream;
comparing an analysis result with the at least one matrix; and
if a position in the at least one matrix corresponding to the at least one analysis result is un-marked, identifying the data stream as safe data.

18. The computer program of claim 17, further performing the step of, if a position in the at least one matrix corresponding to the at least one analysis result is marked, identifying the data stream as unsafe data.

19. The computer program of claim 17, wherein the step of analyzing the data stream further comprising steps for:
a) analyzing a predetermined portion of the data stream;
b) obtaining a partial result;
c) shifting the predetermined portion by a selected amount; and
d) repeating steps a), b), and c) for the entire data stream.

20. The computer program of claim 19, wherein the step of comparing an analysis result further comprising the step of comparing each partial result from a predetermined position of the data stream with one corresponding portion in the at least one matrix.

21. An apparatus for identifying safe data in a data stream, wherein the data stream is received from a network and may contain unsafe data, each unsafe datum being identified by a unique data signature, comprising:
means for receiving data from a data source;
means for storing unsafe data, the means for storing unsafe data having a plurality of entries, each entry having an unsafe datum;
means for generating a plurality of matrices, each matrix having a plurality of elements, each element having two distinguished states; and
means for comparing a received data with a predetermined portion of each unsafe datum, the predetermined portion being less than the entire unsafe datum.

22. The apparatus of claim 21, wherein the means for receiving data is capable of ordering the received data.

23. The apparatus of claim 21, wherein a data signature of an unsafe datum is represented by a plurality of elements in a first state distributed among the plurality of matrices.

24. The apparatus of claim 23, wherein the means for comparing a received data analyzes the received data against the plurality of matrices, wherein if the received data do not match to any element in the first state in the plurality of the matrices, the received data is classified as safe data.

25. The apparatus of claim 21, wherein the means for comparing a received data marks the received data as unsafe data if the received data matches the predetermined portion of any unsafe datum.

26. The apparatus of claim 21, wherein the means for comparing a received data marks the received data as safe data if the received data does not match the predetermined portion of any unsafe datum.

27. The apparatus of claim 26, further comprising means for data processing for processing the safe data.
